(19) United States
(12) Patent Application Publication
(10) Pub. No.: US 2026/0118668 A1
(43) Pub. Date: Apr. 30, 2026

(54) PROJECTION ASSEMBLY

(71) Applicant: SAINT-GOBAIN SEKURIT FRANCE, THOUROTTE (FR)

(72) Inventors: Michele CAPPUCCILLI, HERZOGENRATH (DE); Julian GREVERATH, HERZOGENRATH (DE); Gabriele REUFSTECK, HERZOGENRATH (DE); Martin ARNDT, HERZOGENRATH (DE)

(21) Appl. No.: 19/163,283

(22) PCT Filed: Mar. 6, 2024
(86) PCT No.: PCT/EP2024/055837

§ 371 Date: Sep. 8, 2025

(30) Foreign Application Priority Data
Mar. 9, 2023 (EP) 23160939.7

(51) Int. Cl. G02B 27/01; G06F 3/01; G09G 3/00

(52) U.S. Cl. CPC G02B 27/0101; G02B 27/0179; G06F 3/013; G09G 3/002; G02B 2027/0187; G09G 2340/0464; G09G 2354/00; G09G 2380/10; G09G 2380/12

(57) ABSTRACT

A projection assembly for displaying a virtual image for a viewer whose eye position is located in an eyebox, includes at least a laminated pane having a projection region and a main see-through region, wherein the projection region is arranged outside the main see-through region, and the laminated pane has an opaque masking layer outside the main see-through region at least in the projection region, an image display device arranged on the interior side, which is directed towards the projection region, wherein the image display device is a matrix display, and a control element that is suitable for selectively controlling different matrices of the image display device for displaying the virtual image for different positions of the eyebox.

The invention relates to a projection assembly for a vehicle, a motor vehicle having a projection assembly, and a method for operating a projection assembly.

Modern automobiles are increasingly equipped with so-called head-up displays (HUDs). With a projector, typically in the region of the dashboard, images are projected onto the windshield, reflected there, and perceived by the driver as a virtual image behind the windshield (as seen by the driver). Thus, important information can be projected into the field of vision of the driver, for example, the current travel speed, navigation messages or warnings that the driver can perceive without having to turn his gaze away from the road. Head-up displays can accordingly contribute substantially to increasing traffic safety.

However, head-up displays often have the problem that the region of the windshield which is provided for reflection of the light projected by the projector has to have a high transparency of generally at least 70%. The reflected light of the projector is thus overlaid with light from the external environment, which, depending on the light conditions, can lead to a reduction in contrast of the virtual image and thus to a poorer visual perception for the driver. A sufficient visual perception of, in particular, safety-relevant information such as lane assistance, speed display or rotational speed of the motor should be ensured in all weather and light conditions. In order to achieve a projection assembly that is based on head-up display technology and with which unwanted secondary images are not produced and allows good perceptibility with sufficient brightness and contrast of the displayed image information in a relatively simple manner, the contrast in the reflection region of the windshield can be increased. The contrast increase can be achieved, for example, by the background of the reflection region being largely or completely opaque.

WO 2022/161894 A1 discloses a vehicle pane for a head-up display, comprising at least one transparent pane, at least one first masking strip in an edge region of the pane, and at least one light-directing device for directing light into the vehicle interior or at least one image display device for displaying image information, which is arranged in the region of the masking strip, on the vehicle interior side of the masking strip.

The virtual image is usually created in a so-called eyebox. The eyebox describes a region in the interior of the vehicle in which the eyes of the viewer must be located in order to be able to see the virtual image. An eyebox is therefore referred to as a region whose height and width correspond to a theoretical viewing window. A viewer whose eye position is located within the eyebox can perceive the virtual image; all elements of the virtual image are visible to the viewer. If the eyes move outside the eyebox, the viewer can only perceive part of the virtual image, or may no longer be able to see it at all. The corner points of the eyebox and the virtual image define the cone of vision. The beam path that connects the center of the eyebox with the center of the display is referred to as the center beam.

In head-up displays, the beam direction of the projector can typically be varied by mirrors, in particular vertically, in order to adapt the projection to the body size of the viewer and thus to their vertical eye position. The region in which the eyes of the viewer must be located in a given mirror position in order to perceive the virtual image is referred to as the eyebox, as described above. This eyebox can be displaced vertically by adjusting the mirrors.

DE 10 2015 104 834 A1 discloses a method for setting a relative position between a head-up display device of a motor vehicle and an eye position of a user of the motor vehicle, in which optical information is generated with an imaging unit of the head-up display device, which optical information is reflected within a viewing zone in the direction of the user by a combining mirror of the head-up display device that is movably arranged on a housing of the head-up display device, wherein, depending on the eye position of the user, the housing with the combining mirror as a whole is positionally adjusted in such a way that the viewing zone is directed towards the eye position.

DE 10 2015 109 027 A1 discloses a head-up display unit for a vehicle for generating a virtual image in the driver's field of vision of the vehicle environment, wherein the display unit comprises an emission unit for generating and emitting an image signal that is projected on a multiple-folded projection path into the driver's field of vision, and the display unit comprises at least one movable reflector that influences a part of the projection path, and wherein the representation of the virtual image is influenced by a controlled change in the orientation of the movable reflector as well as additionally by a modification of the emitted image signal compared to an image signal in the raw state, inter alia for compensating for distortions due to the curvature of the windshield and a shift in the eye position along with vehicle movement.

DE 10 2017 130 376 A1 discloses a display device as a head-up display for a vehicle with a lighting unit, which is designed to emit light for displaying a virtual image, and an optical device having a plurality of optical elements that projects the light emitted by the lighting unit onto a display element for displaying the virtual image in an eyebox, wherein the lighting unit is designed for fixed mounting on the vehicle, the display device has a mounting device for fixed mounting on the vehicle, and the optical device is adjustably held on the mounting device by an adjusting device in order to adapt the display of the image or the display on the display element in a mounted state by means of the light emitted by the lighting unit and to adjust the optical device during the adjustment relative to the lighting unit.

DE 10 2021 119 272 A1 discloses a projection unit for a field of vision display device for a vehicle, comprising an imaging unit for generating a light beam with a display content, a mirror arranged in the beam path of the light beam having a first adjusting device that is designed to tilt it for adapting to different eyebox positions of different users and a second adjusting device that is designed for tilting the imaging unit or a further optical component in a way that maintains the image orientation, wherein the projection unit is designed for generating a virtual display image in a virtual image plane in the field of vision of the user by outputting the light beam in the direction of a reflecting pane, from which it is reflected to his eyebox, and the image orientation-maintaining tilt is designed so that the virtual image plane has a predetermined, identical orientation at the different eyebox positions.

DE 10 2016 214 438 A 1 discloses a motor vehicle with a head-up display which comprises a projector for generating individually controllable pixels for displaying an image and a mechanically adjustable optical system for projecting the image onto a pane of the motor vehicle, wherein the motor vehicle has a module for determining the viewing direction or the eye position of a driver of the motor vehicle and/or an occupant of the motor vehicle, and wherein the motor vehicle comprises a control for displacing the pixels by means of the projector depending on a recognized change in the viewing direction and for simultaneously mechanically adjusting the optical system depending on the recognized change in the viewing direction or eye position, wherein the mechanically adjustable optical system comprises at least one mechanically adjustable mirror.

DE 10 2010 040 694 A1 discloses head-up displays for vehicles that use a transparent surface in the vehicle in the viewing direction of a viewer as a display region for displaying information by means of an imaging unit, wherein an imaging optics is arranged between the imaging unit and the display region, having adaptation means with which a display of information can be adapted to different eye positions of the viewer, having a camera for recording the head of the viewer and having an image processing unit for evaluating images from the camera. Projection means are provided to image an optically detectable mark in the direction of the head of the viewer, and the image processing unit is designed to evaluate the mark on the basis of a recording by the camera. The adaptation to different eye positions of the viewer is carried out by means of a rotating mirror.

DE 10 2018 213 363 A1 describes a method for determining setting parameters for a settable component of a motor vehicle, wherein for three or more head positions of a test person in the motor vehicle, the head position and corresponding set setting parameters of the settable component are detected, and an imaging function between the head positions and the setting parameters of the settable component is determined.

DE 10 2017 100 676 A1 discloses a method for calibrating a head-up display of a motor vehicle as well as a corresponding head-up display for a motor vehicle with an infrared camera arranged behind a cold light mirror of the head-up display for detecting infrared radiation and having a computing device.

DE 199 33 769 A1 describes a method and an assembly for the individual and independent functional setting of components of a motor vehicle, in particular components serving the safety of the driver, on the basis of driver-specific characteristic data.

DE 10 2021 101 432 A1 discloses a waveguide-based projection display device having a dynamic scattered light absorber for a vehicle.

WO 2019/238896 A2 discloses a device for generating a virtual image with a distortion element, and DE 10 2016 224 166 B3 discloses a head-up display having image distortion for a vehicle.

WO 2022/218699 A1 discloses a projection assembly comprising a laminated pane and an image display device, wherein the image display device has a 3D image display based on light field technology.

The object of the present invention is to provide an improved projection assembly in which the projection can be adapted to the vertical eye position of the viewer.

The object of the present invention is achieved according to the invention by a projection assembly according to claim 1. Preferred embodiments are apparent from the dependent claims.

The projection assembly according to the invention is suitable for displaying a virtual image for a viewer whose eye position is located in an eyebox and comprises a laminated pane, an image display device and a control element. As usual with HUDs, the image display device irradiates a region of the laminated pane where the radiation is reflected in the direction of the viewer, as a result of which a virtual image is generated that the viewer from his perspective perceives from behind the laminated pane.

The laminated pane has a main see-through region and a projection region. The region of the laminated pane that can be irradiated by the image display device is referred to in this application as the projection region. The region through which a vehicle driver or viewer sees mainly through the laminated pane is referred to as the main see-through region within the scope of this application.

According to the invention, the projection region is arranged outside the main see-through region and therefore does not overlap with it.

The laminated pane according to the invention comprises an outer pane and an inner pane, which are connected to one another via a thermoplastic intermediate layer. The laminated pane is provided to separate the interior from the external environment in a window opening of a vehicle. Within the meaning of the invention, the term “inner pane” refers to the pane of the laminated pane facing the vehicle interior. Outer pane means the pane facing the external environment.

The laminated pane has an upper edge and a lower edge and two side edges extending between them. Upper edge means the edge intended to point upwards in the installed position. Lower edge means the edge intended to point downwards in the installed position. In the case of a windshield, the upper edge is often also referred to as the roof edge, and the lower edge as the engine edge. The lower edge can also be referred to as the pane root.

The outer pane and the inner pane in each case have an outer-side and an interior-side surface and a circumferential side edge extending between them. Within the meaning of the invention, the outer-side surface means the main surface which is intended to face the external environment when installed. Within the meaning of the invention, the interior-side surface means the main surface which is intended to face the interior when installed. The interior-side surface of the outer pane and the outer-side surface of the inner pane face one another and are joined to one another by the thermoplastic intermediate layer.

The outer-side surface of the outer pane is designated as side I. The interior-side surface of the outer pane is designated as side II. The outer-side surface of the inner pane is designated as side III. The interior-side surface of the inner pane is designated as side IV.

The laminated pane also has an opaque masking layer. The opaque masking layer is arranged outside the main see-through region, at least in the projection region.

The image display device is arranged on the interior side, i.e. in the installed position in the vehicle interior, and is directed towards the projection region. The image display device thus irradiates the laminated pane via the interior surface of the inner pane. The interior surface of the inner pane is therefore the surface of the inner pane closest to the image display device.

According to the invention, the image display device is a matrix display. A matrix display is an optical display that consists of individual pixels in a matrix of horizontal rows and vertical columns.

The control element is suitable for selectively controlling different matrices of the image display device for displaying the virtual image for different positions of the eyebox.

The control element is in particular suitable for controlling a first matrix of the image display device at least for an upper position of the eyebox, a second matrix for a middle position of the eyebox, and a third matrix for a lower position of the eyebox. Thus, for displaying a virtual image in an eyebox that is located in an upper position, the image is displayed in a different region of the image display device than for displaying a virtual image in an eyebox that is located in a middle position or in a lower position. Likewise, for displaying a virtual image in an eyebox that is located in a middle position, the image is displayed in a different region of the image display device than for displaying a virtual image in an eyebox that is located in an upper position or in a lower position. Likewise, for displaying a virtual image in an eyebox that is located in a lower position, the image is displayed in a different region of the image display device than for displaying a virtual image in an eyebox that is located in a middle position or in an upper position.

It is understood that the control element may also be suitable for selectively controlling more than three different matrices of the image display device for displaying the virtual image for more than three different positions of the eyebox.

The control of different positions of the eyebox by means of the selective control of matrices of a matrix display offers the advantage over the mechanical adjustment of mirrors of a projector for adjusting the position of the eyebox that the control of the desired matrix can be carried out much faster than the setting of the desired mirror position.

The image display device is preferably an LCD display, LED display, mini-LED display, OLED display or electroluminescent display, in particular an LCD display or miniLED display with local dimming.

The viewer is preferably the driver of a motor vehicle. Alternatively, the viewer could also be, for example, the passenger or another vehicle occupant.

As described above, the region of the laminated pane that can be irradiated by the image display device is referred to in this application as the projection region. It is understood that the region that can be irradiated by the image display device means the entire region that can be irradiated by all possible matrices of the image display device and not only the region that can be irradiated by a single matrix or a selection of matrices of the image display device.

Particularly preferred are embodiments in which the projection region is arranged adjacent to the lower edge of the laminated pane. The projection region can be arranged either directly adjacent or indirectly adjacent to the lower edge. Indirectly adjacent is to be understood as meaning that the projection region is not directly adjacent to the lower edge, but is arranged at a distance therefrom by a few centimeters, for example, in particular by 5 cm to 10 cm.

In a particularly preferred embodiment, the opaque masking layer is arranged in a peripheral edge region and, in particular in a section which overlaps with the projection region, has a greater width than in sections different therefrom. An opaque masking layer arranged in a peripheral edge region also serves as UV protection for the mounting adhesive of the laminated pane.

Preferably, the projection assembly according to the invention additionally comprises an adaptation unit that ascertains the position of the eyebox corresponding to the eye position from information entered by the viewer regarding his eye position, and subsequently outputs an electrical signal to the control element for selectively controlling the matrix corresponding to the ascertained position of the eyebox.

The viewer can preferably indicate, for example, at the beginning of a trip, whether he is tall, medium-sized or short, as a result of which conclusions can be drawn about his eye position, and thus the adaptation unit ascertains the position of the eyebox corresponding to the eye position and subsequently outputs an electrical signal to the control element for selectively controlling the matrix corresponding to the ascertained position of the eyebox.

Alternatively, by setting the seat and/or the rearview mirror and the exterior mirrors, conclusions can be drawn about the eye position of the viewer, and thus the adaptation unit can ascertain the position of the eyebox corresponding to the eye position and subsequently output an electrical signal to the control element for selectively controlling the matrix corresponding to the ascertained position of the eyebox.

Alternatively, the viewer can, preferably at the beginning of a trip, perform a test program of the projection device to indicate his eye position and select when he best sees the virtual image of an image projected by the image display device onto the laminated pane, and in this way transmit his eye position to the adaptation unit, as a result of which the adaptation unit can ascertain the position of the eyebox corresponding to the eye position and subsequently emit an electrical signal to the control element for selectively controlling the matrix corresponding to the ascertained position of the eyebox.

In a particularly preferred embodiment, the projection assembly according to the invention additionally comprises a detection device for detecting the eye position of the viewer and an electrical control device. The electronic control device is configured to ascertain the position of the eyebox corresponding to the eye position on the basis of the eye position ascertained by means of the detection device and to output an electrical signal to the control element for selectively controlling the matrix corresponding to the ascertained position of the eyebox.

Suitable detection devices are known to a person skilled in the art. For example, the detection device can be a thermal imaging camera. The detection device can, for example, also detect the eye position based on infrared radiation, i.e. perform infrared detection, and have a radiation source for emitting infrared radiation and a radiation receiver for receiving infrared radiation.

In embodiments in which the detection device performs infrared detection and comprises a radiation source for emitting infrared radiation and a radiation receiver for receiving infrared radiation, the radiation source and the radiation receiver can be oriented so that the infrared radiation emitted by the radiation source directly strikes the face of the viewer, and the infrared radiation reflected by the face of the viewer directly strikes the radiation receiver.

Alternatively, in embodiments in which the detection device performs infrared detection and has a radiation source for emitting infrared radiation and a radiation receiver for receiving infrared radiation, the laminated pane additionally has a functional layer reflecting infrared radiation, and the radiation source and the radiation receiver are arranged so that infrared radiation emitted by the radiation source can be reflected by the functional layer onto the face of the viewer as first reflection radiation, the first reflection radiation can be reflected by the face of the viewer onto the functional layer as second reflection radiation, and the second reflection radiation reflected by the functional layer as third reflection radiation can be reflected to the radiation receiver and received by the radiation receiver.

The image display device can be designed to be flat in plan view. In a preferred embodiment, the image display device is curved in plan view. The image display device can be curved in the horizontal and/or vertical direction. Through a curvature, the image can be better adapted to the geometry of the pane, as a result of which distortions in the virtual image can be minimized and more easily compensated by means of so-called warping.

The laminated pane is preferably bent in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

In embodiments in which the image display device is curved in plan view and/or the laminated pane is bent, the projection assembly preferably additionally comprises a distortion element. The distortion of the image to be displayed by the image display device caused by the distortion element takes into account the curvature of the image display device and/or the curvature of the laminated pane so that the virtual image can be perceived by the viewer without distortion. As described above, a curvature of the image display device preferably adapts the image to the pane geometry as far as possible so that the distortion element only has to compensate for distortions that are not already compensated for by the curvature of the image display device. The image distortion by means of a distortion element for adapting to a curved image display device and/or a curved laminated pane as a projection surface is also referred to as so-called warping. For this purpose, warping matrices or warping parameter sets are used in particular. Suitable distortion elements are known to a person skilled in the art.

As described above, the laminated pane has an opaque masking layer outside the main see-through region, at least in the projection region, as a result of which a good image display with high contrast against an opaque background formed by the opaque masking layer is made possible so that the image display appears bright and is therefore also highly perceptible. This advantageously makes possible a reduction in the power of the image display device and thus a reduced energy consumption. This is an advantage of the projection assembly according to the invention.

Preferably, the opaque masking layer is formed as a coating of the interior surface of the outer pane or the outer surface of the inner pane, as an opaque insert element arranged between the outer pane and the inner pane, or as an opaquely colored region of the thermoplastic intermediate layer.

The opaque masking layer is preferably a coating made up of one or more layers. Alternatively, however, as described above, it can also be an opaque element, e.g., a film, embedded in the laminated pane. According to a preferred embodiment of the laminated pane, the opaque masking layer consists of a single layer. This has the advantage of a particularly simple and cost-effective manufacture of the laminated pane because only a single layer has to be formed for the opaque masking layer.

The opaque masking layer is in particular an opaque cover print made of a dark, preferably black, enamel. An opaque masking layer designed as an opaque cover print can be over the entire surface. The cover print can also be designed to be semi-transparent at least in sections, for example as a dot matrix, stripe matrix, or checkered matrix. Alternatively, the cover print can also have a gradient, for example from an opaque coverage to a semi-transparent coverage.

An opaque masking layer formed as an opaquely colored region of the thermoplastic intermediate layer can also be realized by using a thermoplastic intermediate layer composed of an opaque thermoplastic film and a transparent thermoplastic film. The opaque thermoplastic film and transparent thermoplastic film are preferably arranged offset from one another, so that the two films are not overlapping when viewed through the laminated pane. The transparent and the opaque film consist of the same plastics or preferably contain the same plastics. The materials on the basis of which the opaque film and the transparent film can be formed are those which are also described for the thermoplastic intermediate layer. The opaque film is preferably a colored film which can have different colors, in particular black.

In a particularly preferred embodiment, the laminated pane additionally comprises a reflective element for reflecting visible light. In this embodiment, a reflective element for reflecting visible light is arranged in the projection region between the outer pane and the inner pane or on the interior surface of the inner pane, wherein the reflective element is arranged spatially in front of the opaque masking layer when viewed through the laminated pane.

The expression “when viewed through the laminated pane” means looking through the laminated pane starting from the interior surface of the inner pane. “Spatially in front of” within the meaning of the present invention means that the reflective element is arranged spatially further away from the outer surface of the outer pane than the opaque masking layer.

According to the invention, a projection assembly for displaying a virtual image for a viewer whose eye position is located in an eyebox thus also comprises at least:
a laminated pane having a projection region, a main see-through region, an upper edge, a lower edge, and two lateral pane edges, wherein the projection region is arranged outside the main see-through region, and the laminated pane comprises an outer pane having an outer surface and an interior surface, an inner pane having an outer surface and an interior surface, and a thermoplastic intermediate layer arranged between the outer pane and the inner pane, and has an opaque masking layer outside the main see-through region at least in the projection region, and wherein a reflective element for reflecting visible light is arranged in the projection region between the outer pane and the inner pane or on the interior surface of the inner pane, which reflective element is arranged spatially in front of the opaque masking layer when viewed through the laminated pane,
an image display device arranged on the interior side, which is directed towards the projection region, wherein the image display device is a matrix display, and
the control element that is suitable for selectively controlling different matrices of the image display device for displaying the virtual image for different positions of the eyebox.

The reflective element can be formed as a coating of the interior surface or the outer surface of the inner pane or the interior surface of the outer pane. The coating can be arranged directly adjacent to the interior surface or to the outer surface of the inner pane or directly adjacent to the interior surface of the outer pane or, alternatively, at least one other layer can be arranged between the particular surface and the coating.

The reflective element can alternatively be formed as a coating on a thin glass pane or film or as a reflective film which is arranged between the thermoplastic intermediate layer and the inner pane, or between the thermoplastic intermediate layer and the outer pane or is glued to the interior surface of the inner pane. The thin glass pane preferably has a thickness of 20 μm to 500 μm, more preferably 50 μm to 300 μm, and most preferably 50 μm to 100 μm, for example 70 μm.

The reflective element preferably reflects at least 10%, particularly preferably at least 40%, very particularly preferably at least 70%, of visible light. The reflective element preferably reflects at most 90% visible light. Within the meaning of the invention, “reflected” means that the reflective element reflects visible light impinging on it. Within the meaning of the invention, reflection in a specific percentage range means an average reflectance at a defined angle of incidence (65°). The reflective element is provided to reflect an image projected onto the reflective element by the image display device. The reflective element can be transparent, but is preferably opaque.

Suitable reflective elements are known to a person skilled in the art.

The reflective element, as described above, is transparent, which within the meaning of the invention means that it has an average transmission in the visible spectral range of at least 70%, preferably at least 80%, and thereby does not significantly limit the view through the laminated pane. In some embodiments, only the projection region of the laminated pane may be provided with the reflective element. In alternative embodiments, however, further regions can also be provided with the reflective element, and the laminated pane can be provided with the reflective element substantially over the entire surface, which may be preferred for production reasons. In one embodiment of the invention, at least 80% of the pane surface is provided with the reflective element. In particular, the reflective element is applied over to the entire surface of the windshield, with the exception of a peripheral edge region and optional local regions, which are intended to ensure the transmission of electromagnetic radiation through the windshield as communication, sensor or camera windows, and therefore are not provided with the reflective element. The peripheral edge region has, for example, a width of up to 20 cm. It prevents direct contact of the reflective element with the surrounding atmosphere so that the reflective element in the interior of the laminated pane is protected against corrosion and damage.

It is understood that, if the reflective element is arranged not only in the projection region but also at least partially in the main see-through region, the reflective element is transparent so that the view through the laminated pane is ensured in the main see-through region.

Preferably, the reflective element is opaque and arranged only outside the main see-through region, and particularly preferably the reflective element is opaque and arranged only in the projection region.

An opaque reflective element is in particular an element containing a mirror layer.

The image display device serves to generate p-polarized light and/or s-polarized light (image information) that strikes the laminated pane in the projection region and is reflected in the direction of the viewer.

In embodiments of the projection assembly according to the invention in which the laminated pane has no reflective element, the radiation of the image display device is preferably completely or almost completely s-polarized (substantially purely s-polarized). The s-polarized radiation proportion is 100% or deviates only slightly therefrom. In these embodiments, the s-polarized light emitted by the image display device is reflected at the interior surface of the inner pane in the direction of the viewer.

In embodiments of the projection assembly according to the invention in which the laminated pane has a reflective element arranged between the outer pane and the inner pane, the reflective element is suitable for reflecting p-polarized radiation, and the radiation of the image display device is preferably completely or almost completely p-polarized (substantially purely p-polarized). The p-polarized radiation proportion is 100% or deviates only slightly therefrom. In these embodiments, the p-polarized light emitted from the image display device is reflected by the reflective element in the direction of the viewer.

In embodiments of the projection assembly according to the invention in which the laminated pane has a reflective element arranged on the interior surface of the inner pane, the reflective element is suitable for reflecting p-polarized and/or s-polarized radiation, and the radiation of the image display device is correspondingly p-polarized and/or s-polarized. In these embodiments, the light emitted by the image display device is reflected by the reflective element in the direction of the viewer.

The radiation emitted by the image display device irradiates a region of the projection region during operation of the projection assembly for generating the projection. The radiation of the image display device lies in the visible spectral range of the electromagnetic spectrum-typical image display devices work with the wavelengths of approximately 470 nm, 550 nm and 630 nm (RGB). Embodiments of the projection assembly in which the laminated pane has a reflective element and the image display device emits p-polarized radiation are preferred since they have the advantage that the virtual image can be seen by wearers of polarization-selective sunglasses which typically only allow p-polarized radiation to pass and block s-polarized radiation.

The term “p-polarized light” means light of the visible spectrum that has p-polarization. The polarization direction is viewed in relation to the plane of incidence of the radiation on the laminated pane. P-polarized radiation refers to a radiation the electric field of which oscillates in the plane of incidence. S-polarized radiation refers to a radiation the electric field of which oscillates perpendicular to the plane of incidence. The plane of incidence is spanned by the incident vector and the surface normal of the laminated pane in the geometric center of the irradiated region. In other words, the polarization, i.e., in particular, the proportion of p-polarized and s-polarized radiation, is determined at a point of the region irradiated by the light source-preferably in the geometric center of the irradiated region. Since laminated panes can be curved (for example, when configured as a windshield), which has effects upon the plane of incidence of the radiation, polarization components slightly deviating therefrom can occur in the other regions, which is unavoidable for physical reasons.

The laminated pane according to the invention is preferably a windshield of a vehicle, in particular a motor vehicle, for example a car or truck. Projection assemblies in which the radiation from the image display device is reflected on a windshield in order to generate an image perceptible to the viewer, in particular the driver, are particularly common.

The outer pane and the inner pane are preferably made of glass, in particular of soda-lime glass, which is customary for window panes. In principle, however, the panes can also be produced from other types of glass (for example borosilicate glass, quartz glass, aluminosilicate glass) or transparent plastics (for example polymethyl methacrylate or polycarbonate). The thickness of the outer pane and the inner pane can vary widely. Preferably, panes having a thickness in the range from 0.8 mm to 5 mm, preferably from 1.4 mm to 2.5 mm, are used, for example those with the standard thicknesses of 1.6 mm or 2.1 mm.

In a preferred embodiment, the inner pane has a thickness of at most 1.6, mm, particularly preferably of at most 1.4 mm, very particularly preferably of at most 1.1 mm.

The outer pane, the inner pane, and the thermoplastic intermediate layer can be clear and colorless, but also tinted or colored. In a preferred embodiment, the total transmission through the windshield (including reflective coating) is greater than 70% in the main see-through region (light type A). The term “total transmission” relates to the method defined by ECE-R 43, Annex 3, § 9.1 for testing the light transmittance of motor vehicle panes. Independently of one another, the outer pane and the inner pane can be non-tempered, partially tempered or tempered. If at least one of the panes is to be tempered, this can be thermal or chemical tempering.

The inner pane is preferably not colored or tinted.

The thermoplastic intermediate layer comprises at least one thermoplastic polymer, preferably ethylene vinyl acetate (EVA), polyvinyl butyral (PVB) or polyurethane (PU), or mixtures, or copolymers, or derivatives thereof, particularly preferably PVB. The intermediate layer is typically formed from a thermoplastic film (joining film). The thickness of the thermoplastic intermediate layer is preferably from 0.2 mm to 2 mm, particularly preferably from 0.3 mm to 1 mm. The thermoplastic intermediate layer can be formed by a single film or also by more than one film. The thermoplastic intermediate layer can also be a film with functional properties, for example a film with acoustic damping properties.

In embodiments, the laminated pane can also have more than one thermoplastic intermediate layer.

The thermoplastic intermediate layer can have a substantially constant thickness, apart from any surface roughness that is customary in the art. Alternatively, the thermoplastic intermediate layer can also be formed as a wedge film.

The laminated pane can be produced by methods known per se. The outer pane and the inner pane are laminated together via the intermediate layer, for example by autoclave processes, vacuum bag processes, vacuum ring processes, calendering processes, vacuum laminators, or combinations thereof. The outer pane and inner pane are usually connected under the effect of heat, vacuum and/or pressure.

If the laminated pane is to be bent, the outer pane and the inner pane are preferably subjected to a bending process before lamination and preferably after any coating processes. Preferably, the outer pane and the inner pane are bent together congruently (i.e. simultaneously and by the same tool) because this optimally matches the shape of the panes to one another for the subsequent lamination. Typical temperatures for glass-bending processes are, for example, 500° C. to 700° C.

For producing the projection assembly according to the invention, the laminated pane and the image display device are arranged relative to one another in such a way that the inner pane faces the image display device, and the image display device is directed towards the projection region.

Also according to the invention is a motor vehicle that has a projection assembly.

Also according to the invention is a method for operating a projection assembly for displaying a virtual image for a viewer whose eye position is located in an eyebox, wherein the projection assembly comprises a laminated pane, an image display device and a control element, and wherein the position of the eyebox is ascertained and the control element selectively controls the matrix of the image display device corresponding to the ascertained position of the eyebox for displaying the virtual image.

The laminated pane has a projection region, a main see-through region, a top edge, a bottom edge and two lateral pane edges, wherein the projection region is arranged outside the main see-through region, and the laminated pane comprises an outer pane having an outer surface and an interior surface, an inner pane having an outer surface and an interior surface, and a thermoplastic intermediate layer arranged between the outer pane and the inner pane, and has an opaque masking layer outside the main see-through region, at least in the projection region.

The image display device is arranged on the interior side, directed towards the projection region and is a matrix display.

The preferred embodiments of the projection assembly according to the invention described above also accordingly apply to the method according to the invention.

The invention further comprises the use of a projection assembly according to the invention in vehicles for traffic on land, in the air or on water, wherein the laminated pane is preferably a windshield.

In the following, the invention is explained in more detail with the aid of drawings and examples of embodiments. The drawings are schematic representations and are not true to scale. The drawings do not limit the invention in any way.

In the drawings:

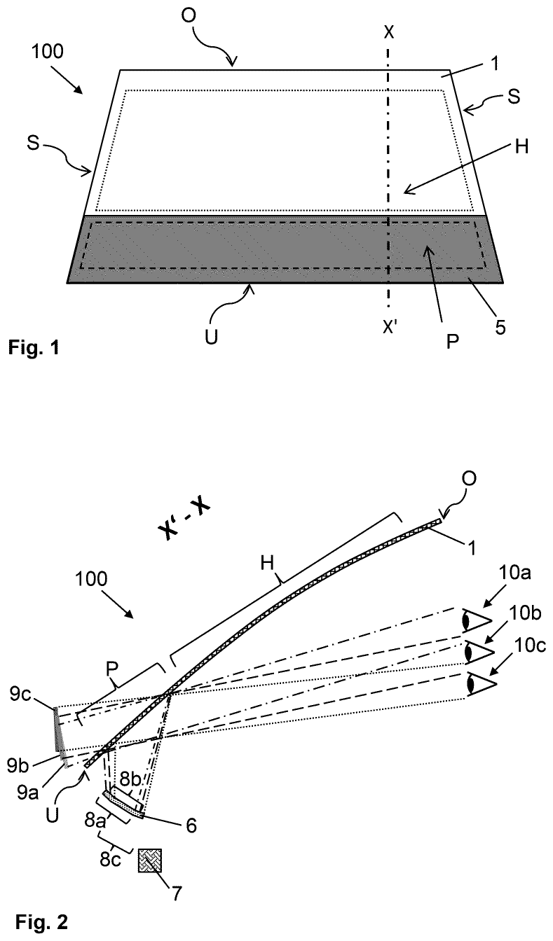

FIG. 1 is a plan view of the laminated pane of an embodiment of a projection assembly according to the invention,

FIG. 2 is a cross-section through the embodiment of a projection assembly according to the invention shown in FIG. 1,

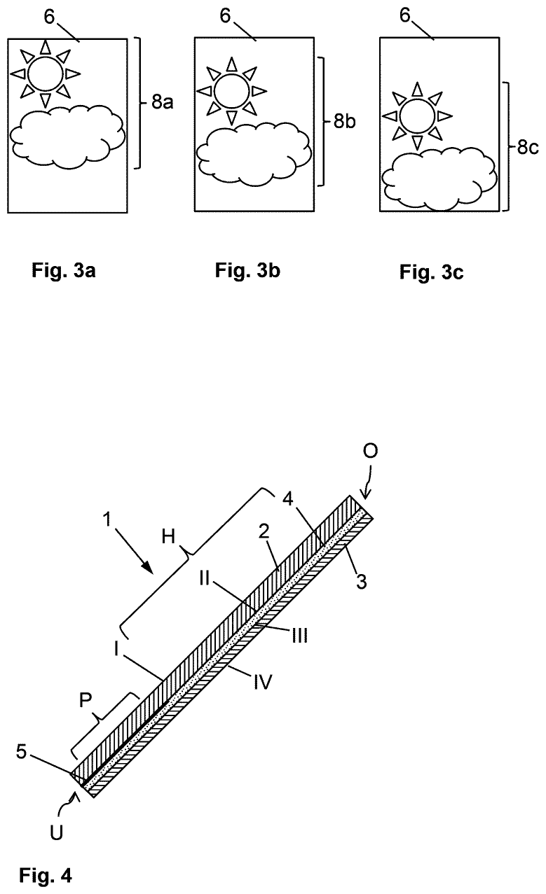

FIG. 3a to 3c are plan views of an image display device,

FIG. 4 is a cross-section of one embodiment of a laminated pane,

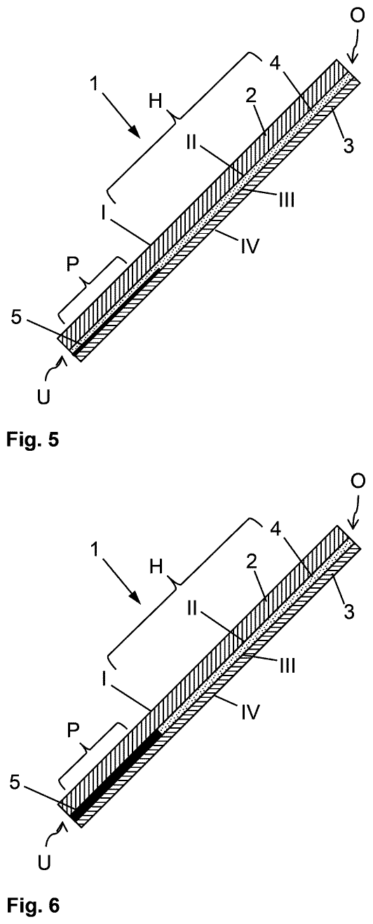

FIG. 5 is a cross-section through a further embodiment of a laminated pane,

FIG. 6 is a cross-section through a further embodiment of a laminated pane,

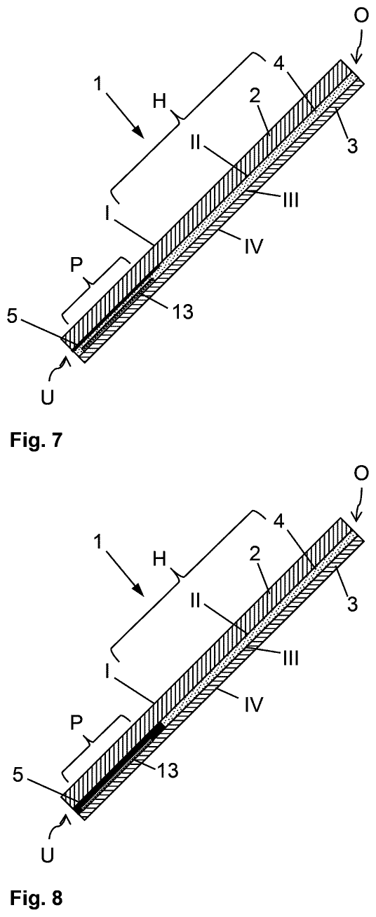

FIG. 7 is a cross-section through a further embodiment of a laminated pane,

FIG. 8 is a cross-section through a further embodiment of a laminated pane,

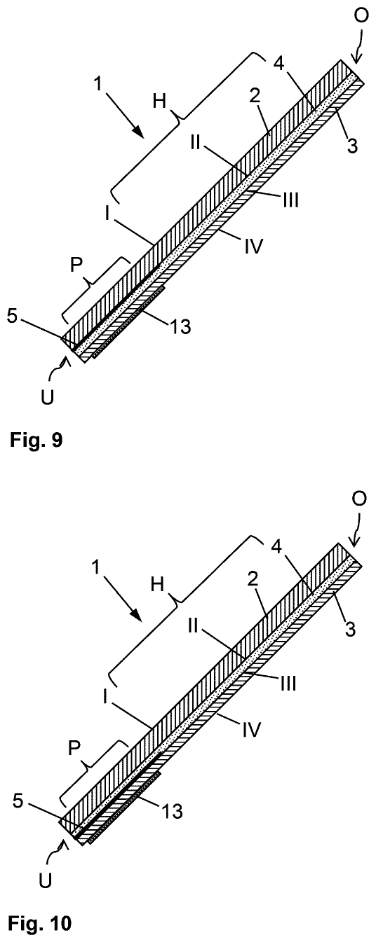

FIG. 9 is a cross-section through a further embodiment of a laminated pane,

FIG. 10 is a cross-section through a further embodiment of a laminated pane,

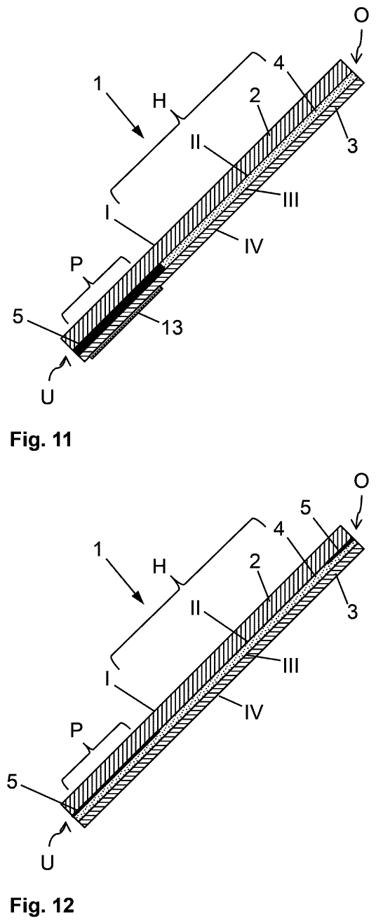

FIG. 11 is a cross-section through a further embodiment of a laminated pane,

FIG. 12 is a cross-section through a further embodiment of a laminated pane, and

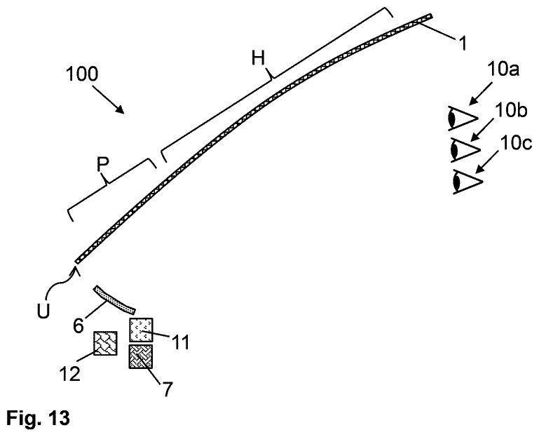

FIG. 13 is a cross-section through a further embodiment of a projection assembly according to the invention.

FIG. 1 shows a plan view of the laminated pane 1 of an embodiment of a projection assembly 100 according to the invention. The laminated pane 1 has an upper edge O, a lower edge U and two lateral pane edges S. In addition, FIG. 1 shows the main see-through region H and the projection region P of the laminated pane 1. In FIG. 1, it can also be seen in which region the laminated pane 1 in the embodiment shown in FIG. 1 has an opaque masking layer 5. In the embodiment shown in FIG. 1, the projection region P is arranged indirectly adjacent to the lower edge U, for example 5 cm away from the lower edge U. The opaque masking layer 5 is arranged directly adjacent to the lower edge U and extends between the side edges S.

FIG. 2 shows a cross-section through an embodiment of a projection assembly 100 according to the invention, wherein this corresponds to the cross-section along the section line X′-X of FIG. 1. As can be seen from FIG. 2, the shown projection assembly 100 according to the invention comprises a laminated pane 1, an image display device 6 and a control element 7.

The laminated pane 1 can be constructed, for example, as shown in FIG. 4 to 12.

The image display device 6 is arranged on the interior side, directed towards the projection region P and is a matrix display. The image display device 6 is, for example, an LCD display.

In FIG. 2, three differently positioned eyeboxes are drawn, the upper eyebox is provided with the reference sign 10a, the middle eyebox with the reference sign 10b and the lower eyebox with the reference sign 10c. The eyeboxes are depicted by eyes in FIG. 2.

In the embodiment shown in FIG. 2, the beam path of three different matrices of the image display device 6 is shown. When the matrix 8a is used, the light emitted by the image display device 6 strikes the laminated pane 1 in a region of the projection region P and is reflected by it in the direction of the viewer, whose eye position is located in the eyebox 10a so that the viewer sees the virtual image 9a. When the matrix 8b is used, the light emitted by the image display device 6 strikes the laminated pane 1 in a region of the projection region P and is reflected thereby in the direction of the viewer whose eye position is located in the eyebox 10b so that the viewer sees the virtual image 9b. When the matrix 8c is used, the light emitted by the image display device 6 strikes the laminated pane 1 in a region of the projection region P and is reflected thereby in the direction of the viewer whose eye position is located in the eyebox 10c so that the viewer sees the virtual image 9c. Depending on the selection of the matrix 8a, 8b, 8c, an adjustment of the position of the eyebox 10a, 10b, 10c arises in the vertical direction.

The control element 7 is suitable for selectively controlling the different matrices 8a, 8b, 8c of the image display device 6 for displaying the virtual image 9a, 9b, 9c for the different positions of the eyebox 10a, 10b, 10c. The different matrices 8a, 8b and 8c partially overlap in the embodiment of a projection assembly 100 according to the invention shown in FIG. 2. However, it is also possible that control element 7 controls different matrices for different positions of the eyebox, which are separate from one another and thus do not at least partially overlap.

FIGS. 3a, 3b and 3c show plan views of an image display device 6 as it can be used in a projection assembly according to the invention.

FIG. 3a shows a plan view of an image display device 6 in which the image is displayed by means of the matrix 8a. FIG. 3b shows a plan view in which the image is displayed by means of the matrix 8b. FIG. 3c shows a plan view in which the image is displayed by means of the matrix 8c. The matrices 8a, 8b and 8c partially overlap with one another.

The non-active region of the image display device 6, i.e. the region outside the particular active matrix, can be completely switched off, as a result of which power can be saved.

FIG. 4 shows a cross-section through an embodiment of a laminated pane 1 for a projection assembly 100 according to the invention. The laminated pane 1 is shown flat in FIG. 4. It is understood that the laminated pane 1 can also be bent as is shown, for example, in FIGS. 2 and 13. In the embodiment shown in FIG. 4, the laminated pane 1 has an upper edge O and a lower edge U. In addition, FIG. 4 shows the main see-through region H and the projection region P of the laminated pane 1. The laminated pane 1 comprises an outer pane 2 having an outer surface I and an interior surface II, and an inner pane 3 having an outer surface III and an interior surface IV which are connected to one another via a thermoplastic intermediate layer 4.

The thermoplastic intermediate layer 4 is, for example, an intermediate layer consisting of PVB and has a thickness of 0.76 mm. The thermoplastic intermediate layer 4 has a substantially constant thickness, apart from a possible surface roughness customary in the art—it is not formed as a so-called wedge film. Alternatively, the thermoplastic intermediate layer 4 can also be formed as a wedge film.

The outer pane 2 and the inner pane 3 consist, for example, of soda-lime glass. The outer pane 2 has, for example, a thickness of 2.1 mm; the inner pane 3 has, for example, a thickness of 1.6 mm or 1.1 mm.

In the embodiment shown in FIG. 4, an opaque masking layer 5 is arranged on the interior surface II of the outer pane 2 adjacent to the lower edge U in a region that is arranged outside the main see-through region H and comprises at least the projection region P. The opaque masking layer 5 is, for example, a cover print made of a dark, preferably black, enamel. Alternatively, the opaque masking layer 5 can also be formed as an opaque insert element arranged between the outer pane 2 and the thermoplastic intermediate layer 4, for example a black polyethylene terephthalate (PET) film.

In a projection assembly 100 according to the invention having a laminated pane 1 according to the embodiment shown in FIG. 4, the radiation of the image display device 6 is preferably completely or almost completely s-polarized, and the s-polarized light emitted by the image display device 6 is reflected at the interior surface IV of the inner pane 3 in the direction of the viewer.

FIG. 5 shows a cross-section through a further embodiment of a laminated pane 1 for a projection assembly 100 according to the invention. The embodiment shown in FIG. 5 differs from that shown in FIG. 4 only in that the opaque masking layer 5 is not arranged on the interior surface Il of the outer pane 2, but on the outer surface III of the inner pane 3. The opaque masking layer 5 is, for example, a cover print made of a dark, preferably black, enamel. Alternatively, the opaque masking layer 5 can also be formed as an opaque insert element arranged between the inner pane 3 and the thermoplastic intermediate layer 4, for example a black PET film.

In a projection assembly 100 according to the invention having a laminated pane 1 according to the embodiment shown in FIG. 5, the radiation of the image display device 6 is preferably completely or almost completely s-polarized, and the s-polarized light emitted by the image display device 6 is reflected at the interior surface IV of the inner pane 3 in the direction of the viewer.

FIG. 6 shows a cross-section through a further embodiment of a laminated pane 1 for a projection assembly 100 according to the invention. The embodiment shown in FIG. 6 differs from the embodiment shown in FIG. 4 only in that the opaque masking layer 5 is not arranged on the interior surface II of the outer pane 2, but is formed as an opaque colored region of the thermoplastic intermediate layer 4.

In a projection assembly 100 according to the invention having a laminated pane 1 according to the embodiment shown in FIG. 6, the radiation of the image display device 6 is preferably completely or almost completely s-polarized, and the s-polarized light emitted by the image display device 6 is reflected at the interior surface IV of the inner pane 3 in the direction of the viewer.

FIG. 7 shows a cross-section through a further embodiment of a laminated pane 1 for a projection assembly 100 according to the invention. The embodiment shown in FIG. 7 differs from that shown in FIG. 4 only in that a reflective element 13 for reflecting visible light is arranged in the projection region P between the inner pane 3 and the thermoplastic intermediate layer 4. The reflective element 13 is formed, for example, as a coating of the outer surface III of the inner pane 3. Alternatively, the reflective element 13 can also be formed as a coating on a thin glass pane or film or as a reflective film that is arranged between the thermoplastic intermediate layer 4 and the inner pane 3. Optionally, the reflective element 13 can also extend over the entire laminated pane 1.

In a projection assembly 100 according to the invention having a laminated pane 1 according to the embodiment shown in FIG. 7, the radiation of the image display device 6 is preferably completely or almost completely s-polarized, and the s-polarized light emitted by the image display device 6 is reflected at the reflective element 13 in the direction of the viewer.

In the embodiment of a laminated pane 1 shown in FIG. 7, the reflective element 13 is arranged between the inner pane 3 and the thermoplastic intermediate layer 4. It is understood that, if the reflective element 13 is formed as a coating on a thin glass pane or film or as a reflective film, it can alternatively also be arranged between the thermoplastic intermediate layer 4 and the outer pane 2, wherein the reflective element 13 is arranged spatially in front of the opaque masking layer 5 when viewed through the laminated pane 1.

FIG. 8 shows a cross-section through a further embodiment of a laminated pane 1 for a projection assembly 100 according to the invention. The embodiment shown in FIG. 8 differs from that shown in FIG. 6 only in that a reflective element 13 for reflecting visible light is arranged in the projection region P between the inner pane 3 and the thermoplastic intermediate layer 4. The reflective element 13 is formed, for example, as a coating of the outer surface III of the inner pane 3. Alternatively, the reflective element 13 can also be formed as a coating on a thin glass pane or film that is arranged between the thermoplastic intermediate layer 4 and the inner pane 3. Optionally, the reflective element 13 can also extend over the entire laminated pane 1.

In a projection assembly 100 according to the invention having a laminated pane 1 according to the embodiment shown in FIG. 8, the radiation of the image display device 6 is preferably completely or almost completely s-polarized and the s-polarized light emitted by the image display device 6 is reflected at the reflective element 13 in the direction of the viewer.

FIG. 9 shows a cross-section through a further embodiment of a laminated pane 1 for a projection assembly 100 according to the invention. The embodiment shown in FIG. 9 differs from that shown in FIG. 4 only in that a reflective element 13 for reflecting visible light is arranged in the projection region P on the interior surface IV of the inner pane 3. The reflective element 13 is formed, for example, as a coating of the interior surface IV of the inner pane 3. Alternatively, the reflective element 13 can also be formed as a coating on a thin glass pane or film or as a reflective film that is glued to the interior surface IV of the inner pane 3. Optionally, the reflective element 13 can also extend over the entire laminated pane 1.

In a projection assembly 100 according to the invention having a laminated pane 1 according to the embodiment shown in FIG. 9, the radiation of the image display device 6 is preferably completely or almost completely s-polarized and the s-polarized light emitted by the image display device 6 is reflected at the reflective element 13 in the direction of the viewer.

FIG. 10 shows a cross-section through a further embodiment of a laminated pane 1 for a projection assembly 100 according to the invention. The embodiment shown in FIG. 10 differs from that shown in FIG. 5 only in that a reflective element 13 for reflecting visible light is arranged in the projection region P on the interior surface IV of the inner pane 3. The reflective element 13 is formed, for example, as a coating of the interior surface IV of the inner pane 3. Alternatively, the reflective element 13 can also be formed as a coating on a thin glass pane or film or as a reflective film that is glued to the interior surface IV of the inner pane 3. Optionally, the reflective element 13 can also extend over the entire laminated pane 1.

In a projection assembly 100 according to the invention having a laminated pane 1 according to the embodiment shown in FIG. 10, the radiation of the image display device 6 is preferably completely or almost completely s-polarized and the s-polarized light emitted by the image display device 6 is reflected at the reflective element 13 in the direction of the viewer.

FIG. 11 shows a cross-section through a further embodiment of a laminated pane 1 for a projection assembly 100 according to the invention. The embodiment shown in FIG. 11 differs from that shown in FIG. 6 only in that a reflective element 13 for reflecting visible light is arranged in the projection region P on the interior surface IV of the inner pane 3. The reflective element 13 is formed, for example, as a coating of the interior surface IV of the inner pane 3. Alternatively, the reflective element 13 can also be formed as a coating on a thin glass pane or film or as a reflective film that is glued to the interior surface IV of the inner pane 3. Optionally, the reflective element 13 can also extend over the entire laminated pane 1.

In a projection assembly 100 according to the invention having a laminated pane 1 according to the embodiment shown in FIG. 11, the radiation of the image display device 6 is preferably completely or almost completely s-polarized and the s-polarized light emitted by the image display device 6 is reflected at the reflective element 13 in the direction of the viewer.

FIG. 12 shows a cross-section through a further embodiment of a laminated pane 1 for a projection assembly 100 according to the invention. The embodiment shown in FIG. 12 differs from that shown in FIG. 4 only in that the opaque masking layer 5 is arranged in a peripheral edge region that has a greater width in a section that overlaps the projection region P than in the sections different therefrom. The region in which the opaque masking layer 5 is arranged thus comprises a peripheral edge region and the projection region P.

It is understood that the laminated panes 1 shown in FIG. 5 to 11 can also be modified in that the opaque masking layer 5 is arranged in a peripheral edge region that has a greater width in a section that overlaps the projection region P than in the sections different therefrom.

In a projection assembly 100 according to the invention having a laminated pane 1 according to the embodiment shown in FIG. 12, the radiation of the image display device 6 is preferably completely or almost completely s-polarized and the s-polarized light emitted by the image display device 6 is reflected at the interior surface IV of the inner pane 3 in the direction of the viewer.

FIG. 13 shows a cross-section through a further embodiment of a projection assembly 100 according to the invention. The embodiment shown in FIG. 13 differs from that shown in FIGS. 1 and 2 only in that the projection assembly 100 additionally has a detection device 11 for detecting the eye position of the viewer and an electronic control device 12. The electronic control device 12 is configured to ascertain the position of the eyebox 10a, 10b, 10c corresponding to the eye position on the basis of the eye position ascertained by means of the detection device 11 and to output an electrical signal to the control element 7 for selectively controlling the matrix 8a, 8b, 8c corresponding to the ascertained position of the eyebox 10a, 10b, 10c. For simplified representation, matrices 8a, 8b, 8c are not marked in FIG. 13.

In the embodiment of the projection assembly shown in FIG. 13, the laminated pane 1 can be designed, for example, as shown in one of FIG. 4 to 12.

### LIST OF REFERENCE SIGNS

100 Projection assembly
1 Laminated pane
2 Outer pane
3 Inner pane
4 Thermoplastic intermediate layer
5 Opaque masking layer
6 Image display device
7 Control element
8a, 8b, 8c Matrix
9a, 9b, 9c Virtual image
10a, 10b, 10c Eyebox
11 Detection device
12 Electronic control device
13 Reflective element
O Upper edge of the laminated pane 1
U Lower edge of the laminated pane 1
S Side edge of the laminated pane 1
P Projection region of the laminated pane 1
H Main see-through region of the laminated pane 1
I Outer surface of the outer pane 2
II Interior surface of the outer pane 2
III Outer surface of the inner pane 3
IV Interior surface of the inner pane 3
X′-X Cutting line

1. A projection assembly for displaying a virtual image for a viewer whose eye position is located in an eyebox, comprising:
a laminated pane having a projection region, a main see-through region, an upper edge, a lower edge, and two lateral pane edges, wherein the projection region is arranged outside the main see-through region, and the laminated pane comprises an outer pane having an outer surface and an interior surface, an inner pane having an outer surface and an interior surface, and a thermoplastic intermediate layer arranged between the outer pane and the inner pane, and has an opaque masking layer outside the main see-through region, at least in the projection region,
an image display device arranged on an interior side, which is directed towards the projection region, wherein the image display device is a matrix display, and
a control element that is configured to selectively control different matrices of the image display device for displaying the virtual image for different positions of the eyebox.

2. The projection assembly according to claim 1, wherein the control element is configured to control a first matrix for at least an upper position of the eyebox, a second matrix for a middle position of the eyebox and a third matrix of the image display device for a lower position of the eyebox.

3. The projection assembly according to claim 1, wherein the opaque masking layer is arranged in a peripheral edge region.

4. The projection assembly according to claim 1, further comprising an adaptation unit that ascertains the position of the eyebox corresponding to the eye position from information entered by the viewer regarding his eye position and outputs an electrical signal to the control element configured to selectively control the matrix corresponding to the ascertained position of the eyebox.

5. The projection assembly according to claim 1, further comprising a detection device for detecting the eye position of the viewer and an electronic control device that is configured to ascertain the position of the eyebox corresponding to the eye position on the basis of the eye position ascertained by the detection device, and to output an electrical signal to the control element to selectively control the matrix corresponding to the ascertained position of the eyebox.

6. The projection assembly according to claim 5, wherein the detection device performs infrared detection and has a radiation source for emitting infrared radiation and a radiation receiver for receiving infrared radiation.

7. The projection assembly according to claim 6, wherein the laminated pane additionally has a functional layer reflecting infrared radiation, and the radiation source and the radiation receiver are arranged so that infrared radiation emitted by the radiation source is reflectable by the functional layer onto the face of the viewer as first reflection radiation, the first reflection radiation is reflectable by the face of the viewer onto the functional layer as second reflection radiation, and the second reflection radiation reflected by the functional layer as third reflection radiation can be reflected to the radiation receiver and received by the radiation receiver.

8. The projection assembly according to claim 1, wherein the image display device is curved in plan view.

9. The projection assembly according to claim 1, wherein the laminated pane is bent.

10. The projection assembly according to claim 8, further comprising a distortion element.

11. The projection assembly according to claim 1, wherein the opaque masking layer is formed as a coating of the interior surface of the outer pane or of the outer surface of the inner pane, as an opaque insert element arranged between the outer pane and the inner pane, or as an opaque colored region of the thermoplastic intermediate layer.

12. The projection assembly according to claim 1, wherein a reflective element for reflecting visible light is arranged in the projection region between the outer pane and the inner pane or on the interior surface of the inner pane, and wherein the reflective element is arranged spatially in front of the opaque masking layer when viewed through the laminated pane.

13. A motor vehicle having a projection assembly according to claim 1.

14. A method for operating a projection assembly for displaying a virtual image for a viewer whose eye position is located in an eyebox,
wherein the projection assembly comprises a laminated pane, an image display device- and a control element,
the laminated pane has a projection region, a main see-through region, an upper edge, a lower edge and two lateral pane edges, wherein the projection region is arranged outside the main see-through region, and the laminated pane comprises an outer pane having an outer surface and an interior surface, an inner pane having an outer surface and an interior surface, and a thermoplastic intermediate layer arranged between the outer pane and the inner pane, and has an opaque masking layer outside the main see-through region, at least in the projection region,
wherein the image display device is arranged on the interior side, is directed towards the projection region and is a matrix display,
and wherein the position of the eyebox is ascertained and the control element selectively controls the matrix of the image display device corresponding to the ascertained position of the eyebox for displaying the virtual image.

15. A use of projection assembly according to claim 1 in a vehicle for traffic on land, in the air, or on water.

16. The projection assembly according to claim 3, wherein the opaque masking layer, in a section which overlaps with the projection region, has a greater width than in sections different therefrom.

17. The use according to claim 15, wherein the laminated pane is a windshield.
